(19) United States
(12) Patent Application Publication
(10) Pub. No.: US 2007/0127114 A1
(43) Pub. Date: Jun. 7, 2007

(54) Method and system for pumping a fiber laser to reduce amplified spontaneous emission and to achieve low pulse repetition frequencies

(76) Inventor: Peter Dragic, Champaign, IL (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 11/489,271

(22) Filed: Jul. 19, 2006

Related U.S. Application Data
(60) Provisional application No. 60/700,504, filed on Jul. 19, 2005.

(51) Int. Cl. H01S 3/00

(52) U.S. Cl. 359/341.1

(57) ABSTRACT

A method for amplifying light in a fiber laser comprising the steps of (a) providing a fiber laser having a laser active dopant; (b) pulse pumping the fiber with a pump having a peak power rating, at a predetermined frequency and at a predetermined duty cycle, wherein the duty cycle is less than one so as to define an effective frequency which substantially minimizing the buildup of ASE; and (c) transmitting a signal pulse after each pumping pulse.

### CROSS-REFERENCE TO RELATED APPLICATION

This application claims the benefit of U.S. Prov. Patent Application Ser. No. 60/700,504 filed Jul. 19, 2005, entitled “METHOD AND SYSTEM FOR PUMPING A FIBER LASER TO REDUCE AMPLIFIED SPONTANEOUS EMISSION AND TO ACHIEVE LOW PULSE REPETITION FREQUENCIES,” the entire specification of which is hereby incorporated by reference.

### BACKGROUND OF THE INVENTION

1. Field of the Invention

The invention relates in general to fiber lasers, and, more specifically to a method and system for pumping a fiber laser to reduce amplified spontaneous emission and to achieve low pulse repetition frequencies.

2. Background of the Invention

Fiber lasers are quickly becoming a preferred laser source in several applications. Notably, the light detection and ranging fiber lasers have increasingly been preferred based upon their superior performance parameters, namely in efficiency, pointing stability, size, and low weight. Unfortunately, pulsed operation of these lasers is substantially limited by amplified spontaneous emission (ASE).

Typically, a fiber laser or amplifier usually consists of a fiber that is doped with a rare earth, such as Erbium or Ytterbium. The fiber is typically continuous-wave (CW) diode pumped by exciting the valence electrons of the system into an upper state. Unless they are directly pumped into metastable levels, these electrons then relax to the metastable levels, which have relatively long decay times. For example, the ²F_{5/2} metastable level of Yb typically has an upper state lifetime on the order of 1 ms in silica glasses. The ⁴I_{13/2} of Er typically has a lifetime close to 10 ms in silica.

Ideally, it is desired that all of the excited atoms will act to amplify the laser signal present in the laser fiber. This would provide maximum laser or amplifier efficiency. However, some of these excited atoms will spontaneously de-excite, adding to system noise. Because some of this spontaneous emission is captured and guided by the fiber, it is also amplified by the excited states, which is termed amplified spontaneous emission. In pulsed systems, ASE is particularly destructive since it steals energy from the desired laser signal, greatly diminishing laser performance.

The inverse of the upper state lifetime (1 kHz for Yb and 100 Hz for Er) is typically understood as the absolute minimum pulse repetition frequency (PRF) at which the fiber laser can operate. This is the 1/e point, where 37% of the initial pump excitation remains, with 63% contributing to ASE. This operating point then usually has diminished output power, and signal output is dominated by ASE. This is because ASE can basically bleed power out as fast as you can pump the fiber. However, in many systems, such as Yb doped lidar systems, even slower PRFs are desired.

Optimal amplifier performance is achieved at infinite PRF, or CW operation of the fiber laser. With a higher PRF, the fiber laser or amplifier will perform with much higher efficiency and be less affected by ASE. For example, a 10 kHz Yb-doped fiber laser will perform with much higher efficiency than a 1 kHz Yb-doped fiber laser.

Several methods have been attempted to suppress ASE. Pumping direction relative to the direction of the signal can be optimized somewhat to alter the ASE distribution in the fiber, but the inverse of the upper state lifetime is still the limiting factor. Likewise, ring-doped structures have also been developed to suppress ASE. However, longer fiber lengths are required, which is a drawback when considering nonlinear effects in fiber. Also, the upper state is still the limiting factor in this type of a fiber laser.

Thus, it is an object of the invention to provide a fiber laser which resembles high PRF fiber laser operation while retaining low PRF.

This and other objects of the invention will become apparent in light of the specification and claims appended hereto.

### SUMMARY OF THE INVENTION

The invention comprises a method for amplifying light in a fiber laser. The amplification is achieved by way of the following steps, namely, providing a fiber laser having a laser active dopant; pulse pumping the fiber with a pump having a peak power rating, at a predetermined frequency and at a predetermined duty cycle, wherein the duty cycle is less than one so as to define an effective frequency which substantially minimizes the buildup of ASE; and transmitting a signal pulse after each pumping pulse.

The laser active dopant may comprise a rare earth dopant. Among other dopants, it is contemplated that the rare earth dopant may comprise any one or more of: erbium, ytterbium, neodymium, thulium, samarium, europium. These may be used alone or in combination.

### BRIEF DESCRIPTION OF THE DRAWINGS

FIG. 1 of the drawings comprises a schematic representation of a simplified 2-level energy level diagram;

FIG. 2 of the drawings comprises a normalized upper state population vs. time for the cases set forth in Table 1.

FIG. 3 of the drawings comprises a representation of temporal pumping characteristics, wherein the duty cycle is the ratio of the pumping pulse width divided by 1/PRF.

### DETAILED DESCRIPTION OF THE INVENTION

While this invention is susceptible of embodiment in many different forms, there is shown in the drawings and will be described in detail, a specific embodiment with the understanding that the present disclosure is to be considered as an exemplification of the principles of the invention and is not intended to limit the invention to the embodiment illustrated.

In order to achieve low-PRF pulsed operation, a pulsed-mode-pumping scheme (PMP) is contemplated. Fiber-coupled laser diode pump arrays in the 9XX nm wavelength range are available with power outputs exceeding several kilowatts, CW. Increased-inversion, and extremely high efficiency fiber lasers and amplifiers are possible at greatly reduced PRF when-high power fiber-coupled diode arrays such as these are operated (current-driven) with a duty cycle (DCY) of less than one.

In such a embodiment, the pumping rate in a fiber can be described by the following equation:

$$R ( t ) = \frac{{P}_{p} ( t )}{{A}_{eff} {hv}_{p}} {σ}_{p}^{a} \qquad ( 1 )$$

In Eqn. 1, Pₚ(t) is the functional form of PMP with a characteristic peak power (rated output power of the pump) and DCY. A_{eff} is the effective area of the pump, h is Planck's constant, and v is the optical pumping frequency. Finally, σₚ¹ is the absorption coefficient at the pumping wavelength.

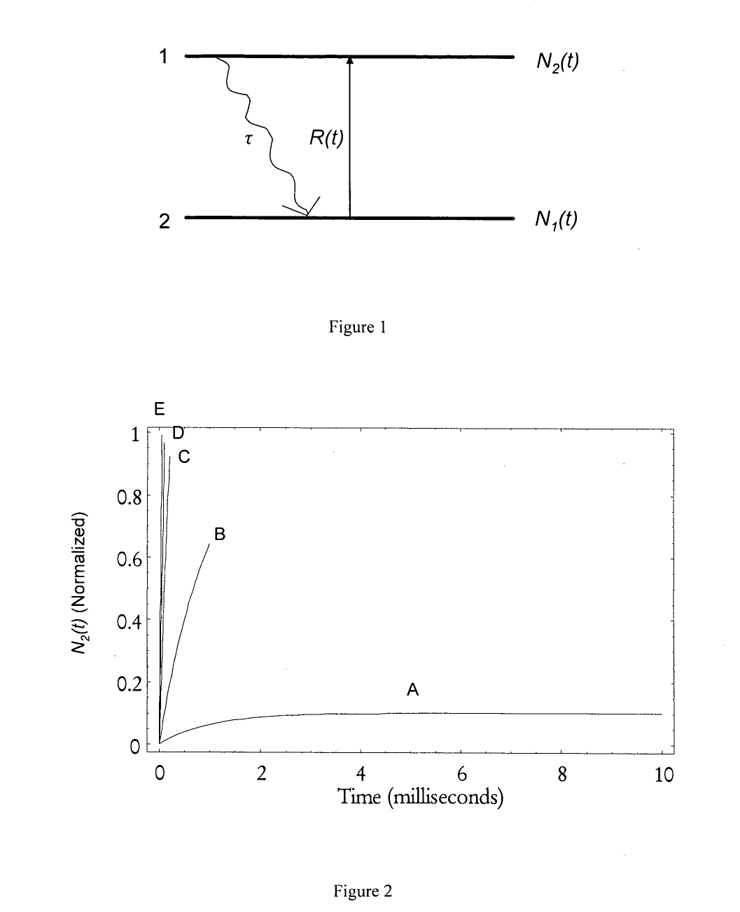

A simplified 2-level energy level diagram shown in FIG. 1. The rate equation governing the excited state of this system is:

$$\frac{ⅆ {N}_{2} ( t )}{ⅆ t} + \frac{{N}_{2} ( t )}{τ} = R ( t ) \qquad ( 2 )$$

where τ is the upper state lifetime. The boundary (initial) condition for this equation is N₂(t=0)=0.

This gives rise to the following solution for the population of the upper state at the start of each pump pulse:
N₂(t)=R(t)τ(1−e^{-1/σ)} (3)

An estimation of inversion can be established by plotting N₂(t) for an example configuration. For example, it is desired to pump at an average power of 10 Watts for the example configuration. Several example cases are shown in Table 1. The average power is found by multiplying the DCY by the rated pump power. A duty cycle of one is equivalent to CW pumping. All of the cases are providing an average of 10 Watts of pump power. The last column shows how long the pumping pulse has to be for an example PRF of 100 Hz. The same energy is being delivered to the fiber in all cases.

TABLE 1
Example cases for the calculation.

| | | Rated Maximum (peak) | Pumping Pulse | |
|---|---|---|---|---|
| Case | Duty Cycle | Pump Power (Watts) | Width | |
| A | 1 | 10 | 10 | milliseconds |
| B | 0.1 | 100 | 1 | millisecond |
| B | 0.02 | 500 | 200 | microseconds |
| D | 0.01 | 1000 | 100 | microseconds |
| E | 0.005 | 2000 | 50 | microseconds |

Utilizing a Yb-doped fiber, τ≈1 ms. The pumping configuration is also typical of an Yb-doped dual clad fiber. The embodiment contemplates a pumping wavelength of 915 nm, an outer cladding diameter of 400 micrometers, and a pumping absorption cross section of about 7.5×10⁻²⁵ m².

With reference to FIG. 2, for each of the cases in Table 1, the N₂ is plotted as a function of time up to the required pumping time provided in Table 1. It becomes clear from the data in FIG. 2, that the population of the upper state is greatest in Case E, or as we drive the pump into lower duty cycles. The lowest inversion is achieved by Case A, or the CW case, as is the current state of the art. Accordingly, for the same energy, or average power input into the laser fiber, the inversion is increased by over a factor of 10 from Case A to Case E. This corresponds to 10 times more available power than CW-pumping.

The foregoing embodiment comprises a dual clad fiber. However, it will be understood to those skilled in the art that PMP can work equally well for single- or multiply-clad laser fibers. This also includes laser fibers of all various laser-active dopant content, including but not limited to erbium, ytterbium, neodymium, thulium, samarium, europium, among others, each with its own material-dependent characteristic lifetime T .

Furthermore, since the pumping duration can be very short in PMP, less depopulation of the upper state occurs. For example, in Case A above, the initial upper state inversion completely de-excites to achieve steady-state fiber laser/amplifier operation. However, in Case E, the pumping pulse is 20 times shorter than the upper state lifetime of 1 millisecond. As a result, ASE is not allowed to build up, and a steady-state ASE condition is not achieved. As a result, there is an “effective” PRF (EPRF) at which the laser operates. In certain circumstances, even at low-PRF, the laser can operate very efficiently as a quasi-CW laser. The EPRF is provided in Table 2 for each case of Table 1.

TABLE 2
EPRF for the cases of Table 1.

| Case | Duty Cycle | PRF (Hz) | EPRF (Hz) |
|---|---|---|---|
| A | 1 | 100 | 100 |
| B | 0.1 | 100 | 1000 |
| B | 0.02 | 100 | 5000 |
| D | 0.01 | 100 | 10000 |
| E | 0.005 | 100 | 20000 |

Accordingly, the performance of the PMP-based fiber laser or amplifier improves as the rated pump power increases and the DCY decreases. Advantageously, as the pump can now be operated at a substantially reduced DCY relative to the rated CW value, it allows pumps normally required to be water cooled to be operated air-cooled. In turn, This conserves energy and decreases the payload (weight and footprint) of fiber laser based systems.

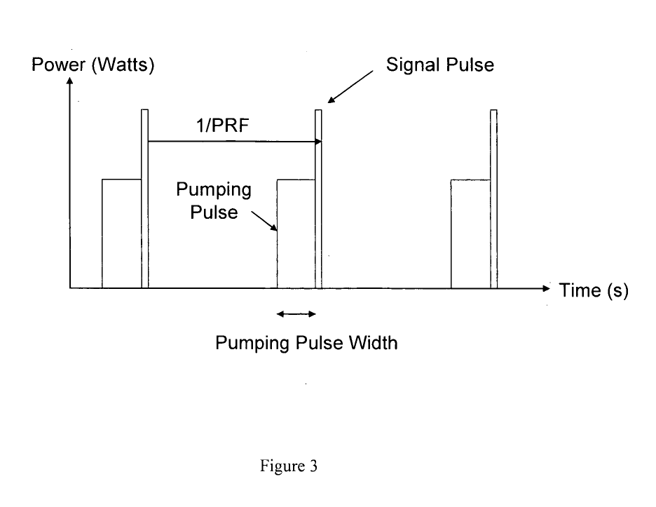

Finally, the signal or laser pulse appears soon after the falling edge of the pumping pulse. One sample preferred PMP configuration including signal pulse timing is illustrated in FIG. 3. Otherwise, upper state depopulation will degrade laser/amplifier performance. The signal pulse may appear as a signal pulse to be amplified in an amplifier, originating, for example from a master oscillator. Or, the signal pulse can be a laser pulse, for example generated when a Q-switch is opened in a Q-switched fiber laser configuration.

The foregoing description merely explains and illustrates the invention and the invention is not limited thereto except insofar as the appended claims are so limited, as those skilled in the art who have the disclosure before them will be able to make modifications without departing from the scope of the invention.

What is Claimed is:

1. A method for amplifying light in a fiber laser comprising the steps of:
providing a fiber laser having a laser active dopant;
pulse pumping the fiber with a pump having a peak power rating, at a predetermined frequency and at a predetermined duty cycle, wherein the duty cycle is less than one so as to define an effective frequency which substantially minimizes the buildup of ASE; and
transmitting a signal pulse after each pumping pulse.

2. The method of claim wherein the laser active dopant comprises a rare earth dopant selected from one of the group consisting of: erbium, ytterbium, neodymium, thulium, samarium and europium.
